(19) United States
(12) Patent Application Publication
(10) Pub. No.: US 2024/0253291 A1
(43) Pub. Date: Aug. 1, 2024

(54) Method for Producing Film from a Total Amount of Raw Materials Using a Film Extrusion Machine, and Computer Program Product for Carrying Out the Method

(71) Applicant: Windmöller & Hölscher KG, Lengerich (DE)

(72) Inventors: Martin Backmann, Lengerich (DE); Markus Bussmann, Lengerich (DE); Wolfgang Hoffmann, Lengerich (DE); Melanie Schuh, Lengerich (DE); Torsten Schmitz, Lengerich (DE)

(21) Appl. No.: 18/560,537

(22) PCT Filed: May 4, 2022
(86) PCT No.: PCT/EP2022/062004

§ 371 Date: Nov. 13, 2023

(30) Foreign Application Priority Data
May 14, 2021 (DE) 10 2021 112 619.3

(51) Int. Cl. B29C 48/92; B29C 48/08

(52) U.S. Cl. CPC B29C 48/92; B29C 48/08; B29C 2948/9218

(57) ABSTRACT

The invention relates to a method for producing a plastic film from a total amount of raw materials using a film extrusion machine. According to the invention, the method comprises the following steps:
detecting film parameters relating to desired properties of the plastic film,
detecting raw material parameters relating to properties of the raw materials,
grouping the raw material parameter into at least two raw material parameter groups,
forming correlations between raw material parameter groups,
forming correlations between film parameters and the raw material parameter groups based on a film production model,
detecting a selection of at least one raw material from at least one raw material parameter group,
calculating at least one production parameter of the film extrusion machine based on the film production model.

The invention relates to a method for producing a plastic film from a total amount of raw materials using a film extrusion machine, and a corresponding computer program product.

It is known that for the production of film with desired properties, production parameters are set in film extrusion lines. In the process, a plurality of production parameters is to be considered. For example, temperatures, pressures or other physical variables that act directly on the raw materials, the intermediate products and/or the finished film have to be set at many points. This applies, in particular, to setting, i.e., open-loop and/or closed-loop controlling the film extrusion line.

The properties of the film produced can then be characterized, particularly in the laboratory, but also during production. In particular, the actual fulfillment of a function of the film, but also measurable film parameters such as tear resistance or stretchability of the film, are examined.

In regard to the open-loop and/or closed-loop control of the film extrusion line, known solutions are mainly based on the experience and the knowledge of the operating personnel.

The same applies to the raw materials. Again, the raw materials are selected based on experience, experiments and the manufacturers' specifications on the raw materials.

Overall, the production of a film with desired properties may require lengthy preparatory work, which can also be expensive.

It is the object of the present invention to at least partially eliminate the aforementioned disadvantages. It is, in particular, the object of the present invention to produce a film with desired properties more cost-effective and in a simpler manner.

The above object is accomplished by a method having the features of claim 1 and a computer program product having the features of claim 6. Further features and details of the invention derive from the dependent claims, the description and the figures. Features and details which are described in the context of the method according to the invention naturally also apply in the context of the computer program product according to the invention and vice versa, respectively, so that reference is or can always be made to the individual aspects of the invention reciprocally with respect to the disclosure.

The method according to the invention relates to the production of plastic film from a total amount of raw materials using a film extrusion machine. The method comprises the following steps:
detecting film parameters relating to desired properties of the plastic film,
detecting raw material parameters relating to properties of the raw materials,
grouping the raw material parameter into at least two raw material parameter groups,
forming correlations between raw material parameter groups,
forming correlations between film parameters and the raw material parameter groups based on a film production model,
detecting a selection of at least one raw material from at least one raw material parameter group,
calculating at least one production parameter of the film extrusion machine based on the film production model,
outputting the production parameter of the film extrusion machine.

The core idea of the invention is thus to not simply make a selection from the available total amount of raw materials, but to first classify the raw materials into groups, i.e., to group them, according to their parameters, i.e., their properties. The grouping can be multidimensional and can comprise as many groups as desired by the user of the film extrusion machine. This means that a grouping of a raw material may relate to the temperature range at which this raw material is to be processed in the film extrusion machine. In general, there can be a number of groups that relate to the processing properties of the raw material.

Another aspect of a grouping may relate to the resulting properties of the raw material in the film. This means that raw materials that represent a permeability range for a specific gas may be compiled in a group. The quality of adhesion of molecules of one raw material to molecules of another raw material may also be sorted into groups. Furthermore, economical aspects may play a role and may be used for grouping the raw materials. This means that each raw material may be added to a group based on its price, wherein a group represents a price range. Additional groupings may relate to the time frame in which the raw material is available. Moreover, the approval of specific raw materials for specific applications may be a basis for a grouping. For example, not all raw materials are approved for food packaging. Additionally, raw materials may be grouped with regard to their environmental sustainability. Many other groupings are conceivable.

The grouping of the raw materials is based on the acquisition of properties. The properties can be basic properties of the raw materials, such as the chemical composition, but also, for example, their manufacturing parameters, such as the operating parameters of the manufacturing plant. A further parameter can be a manufacturing date. Such raw material parameters can be made available to the user of the film extrusion line, that is to say, the manufacturer of the plastic film, at least in part by the raw material manufacturer. The results of tests, such as chemical analysis, can also be included. It makes sense to save the raw material parameters in a database. Said database may, for example, be stored in an Internet data memory on an external server operated by a data provider.

It is advantageous, when a raw material manufacturer only releases selected properties of the raw materials (information) for said database or within said database. This enables the raw material manufacturer, for example, to make the information available to the user for a fee, depending on the quantity and importance of the information.

Furthermore, according to the invention, a step is provided in which a correlation between the film parameters and the raw material parameter groups is formed. This relationship is based on a film production model in which the influence of raw materials from raw material parameter groups on the properties of the film is mapped. Consequently, it is possible to output a selection of raw materials for the desired properties, preferably one or more raw materials for each property of the film.

However, to avoid, for example, that incompatible raw materials can be selected, it is provided according to the invention that correlations are also formed between individual raw material parameter groups.

After determining possible combinations of raw materials to be considered for the production of the film, it is provided to make a selection from the raw materials, which is detected in a step according to the invention. It is advantageous if the detected selection is verified. In particular, it is determined whether the selection leads to the desired film. “Detecting at least one raw material from at least one raw material parameter group” can also mean that a selection of raw materials is calculated directly from the raw material parameter groups.

Finally, to ensure that the desired film is actually extruded within the film extrusion machine, it is provided that, based on the film production model, at least one film production parameter for the film extrusion machine is calculated from acquired data and output. It is thus possible to leave the setting of the parameters of the film extrusion machine not solely to the machine operator, so that the desired film, in particular a film of the desired quality, is produced.

Film extrusion machines can mean all extrusion machines, but also downstream components with which the raw materials can be converted into a film, but also downstream machine components, such as stretching devices for example, to winding devices in which the film is wound up for the first time for transportation. An extrusion machine can operate according to the principle of a blown film line or a cast film line. Within the meaning of the present invention, “detecting” can mean various types of data acquisition. These may already be available in the form of information, in particular, in digital form. For this purpose, various databases are conceivable. Data acquisition can also occur through direct input by the user or trough measurement by means of measuring instruments. In particular, upstream machines in the production process, such as a raw material production machine, can transmit data, especially measurement data, to a machine in a downstream production process via data connections.

The term “output” is to be understood in the same way. This means that the production parameters can be displayed on a monitor or they can be made available to the machine operator of the film extrusion machine in another way. It is also conceivable, that the computing device, which carries out said calculations, transfers those via data connections directly to the film extrusion machine, in particular, to its control device.

In an advantageous further development of the invention, detecting a level of detail for the raw material parameter groups is provided. This can be used, for example, to specify, how small or large the parameter ranges of the raw material parameters are. For example, if the parameter range is too narrow, it may happen that no raw material that meets one of the requirements is available. In this case, the parameter range can be adjusted so that an extended raw material selection is possible.

In a further advantageous embodiment of the invention, an outputting of selection suggestions for a selection of raw materials is provided. In other words, for at least one material parameter group, at least two raw materials are output from which a raw material is to be selected. In particular, in this embodiment a rating can be output for each of the raw materials of the selection suggestion. Based on said rating, the influence of the raw materials on the plastic film can be assessed. For example, a plastic film can be produced that does not fully meet the quality requirements compared to the desired film, but which is significantly cheaper.

It is further advantageous, when the raw material parameter groups are weighted. In this case, the individual raw material parameter groups can be assigned a weighting that is taken into account in the correlation between the individual raw material parameter groups. In other words, the film production model can be adjusted with these weightings.

The invention can be improved again, if production parameter ranges of at least one film production machine are detected. Said production parameter ranges can be used to increase the number of possible raw materials and to make an optimal selection from these. Conversely, the selection of raw materials can be adapted to the optimum operating parameters of the film production machine, for example.

“Detecting” refers to different types of detecting. For example, unchangeable parameters for the film production machine can be detected once in a database. This is, for example, the case with geometrical properties of the film extrusion machine. Other parameters may change at intervals, such as details of the raw material available. Yet other parameters, such as the desired properties of the film, can be detected on an order-related basis. Accordingly, the parameters can also be detected on the basis of different characteristics. For example, the parameters are made available via databases which are, for example, stored in the memory of the film extrusion machine or decentrally in Internet portals. In this case, detecting would be referred to as “reading out data”. Order-related parameters, for example, can be detected via input devices such as a keyboard.

It can be advantageous in the context of the method according to the invention, to detect machine parameters and/or setting for at least one film extrusion machine. Machine parameters can be detected, in particular, during commissioning, during which, for example, geometric data of the film extrusion machine are stored in a database. Said geometric data include, in particular, the maximum number of layers, the maximum number of individual raw materials that can be used for each individual layer, the design of extruder screws for melting-on the raw materials, the width or circumference of the die lip, the thickness of the die lip. This list is not exhaustive and therefore not limiting with respect to the invention.

Further advantages may result if a recommendation is made as to which film extrusion machine should be selected for producing the desired film, if several film extrusion machines, in particular, different film extrusion machines for producing the film are generally available. Often times, several film extrusion lines are available at a manufacturing facility that are different from one another with regard to the geometric data but also with regard to their physical parameters. In such a situation, it is possible to select one of these lines based on the film production model. For example, with a desired film with a five-layer structure, it may advantageous if the product is produced on a film extrusion line for films with maximally seven-layer structure.

Also the subject of the present invention is a computer program product comprising instructions which, when the program is executed on a computer, cause the computer to carry out the steps of a method according to the invention. Thus, a computer program product according to the invention has the same advantages as those explained in detail with reference to a method according to the invention.

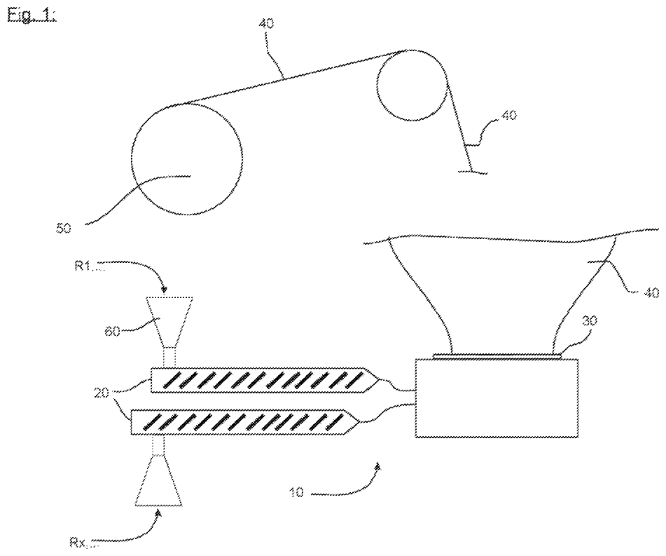

FIG. 1 schematic illustration of a film extrusion machine,

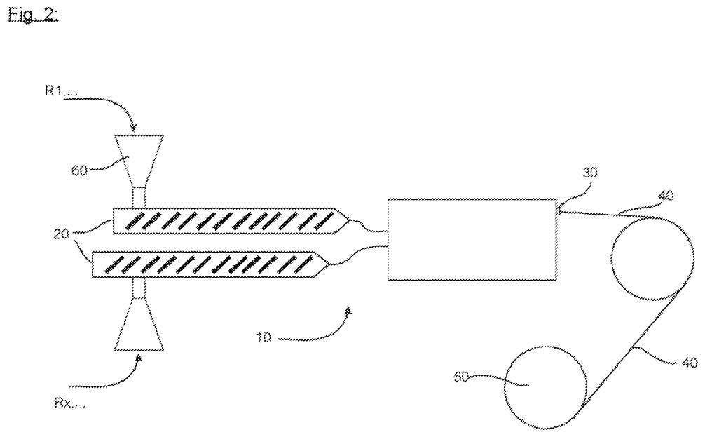

FIG. 2 schematic illustration of a different film extrusion machine,

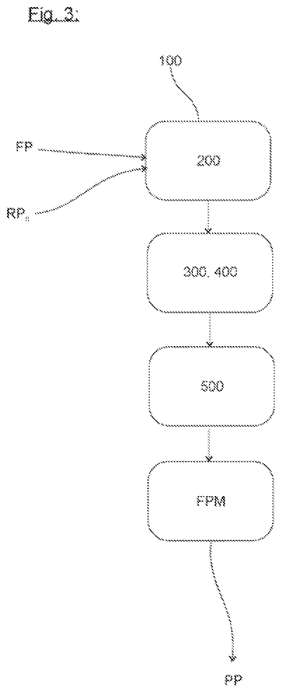

FIG. 3 schematic illustration of the sequence of a method according to the invention.

In FIGS. 1 and 2, film extrusion machines 10 are shown by way of example. The film extrusion machines have in common that they are equipped with extruders 20. Each individual extruder supplies the film extrusion machines with melted plastic material for a layer of the subsequent film. For this purpose, a first extruder is supplied with one or more raw materials R1, . . . . via dosing devices 60, a second extruder is supplied with one or more raw materials Rx . . . in said manner. The raw materials are generally provided in the form of plastic granulate. The type and/or quantity of the supplied raw materials are predetermined by the method according to the invention.

The method according to the invention can be carried out using a cast film extrusion line or a blown film extrusion line as shown in FIG. 2. FIG. 1 shows a blown film line comprising the already described extruders 20. A film web or film 40 for short is discharged from the die 30, the die 30 being designed as an annular blow die. The film web is initially formed as bubble which is later laid flat. Said film, which now comprises two individual films placed one on top of the other, is wound counter-clockwise onto one winding roller 50 or, after cutting, onto two winding rollers.

The film extrusion machine in FIG. 2 is a cast film extrusion machine, which, as an example, is also equipped with two extruders 20 for different compositions. A film web 40 is discharged from the die 30, which film web cools down on a cooling roller and is subsequently wound onto a winding roller 50.

FIG. 3 schematically shows the process of the method according to the invention. A memory and computing unit 100 is provided with film parameters FP relating to the desired properties of the film and raw material parameters RPn relating to the properties of the raw materials. The index n of the raw material parameters RP indicates that this is an entirety of raw materials from which one or more raw materials are selectable. First a grouping of the raw material parameters into at least two raw material parameter groups is carried out in the memory and computing unit, which is indicated with the reference sign 200. In two subsequent steps, which may be carried out in any order or simultaneously, correlations are formed between raw material parameter groups and correlations are formed between film parameters and the raw material parameter groups 400 based on a film production model which is stored and/or executed within the memory and computing unit. In the subsequent step 500, a selection of at least one raw material from at least one raw material parameter group is detected.

After the control and computing unit 100 has calculated at least one production parameter PP of the film extrusion machine based on the film production model, the production parameter of the film extrusion machine is output.

### REFERENCE SIGN LIST

10 Film extrusion machine
20 Extruder
30 Die
40 Film web
50 Winding roll
60 Dosing device

1. A method for producing a plastic film from a total of raw materials with a film extrusion machine, comprising the following steps:
capturing film parameters relating to desired properties of the plastic film,
detecting raw material parameters relating to properties of the raw materials,
grouping the raw material parameter into at least two raw material parameter groups,
forming correlations between raw material parameter groups,
forming correlations between film parameters and the raw material parameter groups based on a film production model,
detecting a selection of at least one raw material from at least one raw material parameter group,
calculating at least one production parameter of the film extrusion machine based on the film production model,
outputting the production parameter of the film extrusion machine.

2. The method according to claim 1 comprising the following step: detecting a level of detail for the raw material parameter groups.

3. The method according to claim 1, additionally comprising the following step:
outputting selection suggestions for selecting raw materials.

4. The method according to claim 1, additionally comprising the following step:
weighting raw material parameter groups.

5. The method according to claim 1, additionally comprising the following step:
detecting production parameter ranges of at least one film production machine.

6. A computer program product comprising instructions which, when the program is executed on a computer, cause the computer to carry out the steps of a method according to claim 1.
